(19) United States
(12) Patent Application Publication
(10) Pub. No.: US 2026/0298764 A1
(43) Pub. Date: Oct. 1, 2026

(54) A NOVEL TECHNIQUE FOR LEAK DETECTION AND QUANTIFICATION USING FIBER BRAGG GRATINGS

(71) Applicant: Board of Supervisors of Louisiana State University and Agricultural and Mechanical College, Baton Rouge, LA (US)

(72) Inventors: Jagadeeshwar Tabjula, Baton Rouge, LA (US); Jyotsna Sharma, Baton Rouge, LA (US)

(21) Appl. No.: 19/476,739

(22) PCT Filed: Apr. 22, 2024
(86) PCT No.: PCT/US2024/025625

§ 371 Date: Oct. 20, 2025

Related U.S. Application Data
(60) Provisional application No. 63/461,955, filed on Apr. 26, 2023.

(51) Int. Cl. G01M 3/38; G01D 5/26; G02B 6/02

(52) U.S. Cl. CPC G01M 3/38; G01D 5/268; G02B 6/02085

(57) ABSTRACT

In one aspect, the disclosure relates to a system and method for detecting leaks in fluid handling systems, including, but not limited to, wells, pipelines, and storage tanks for natural gas and petroleum products. In another aspect, the system includes one or more optical fiber sensors having fiber Bragg gratings (FBGs) wherein a perturbation of the system causes a reflected wavelength shift. In the disclosed method, data collected from the FBG-containing sensors is detrended using a non-linear detrending algorithm after subtracting a synthetic baseline from raw data, thereby extracting and quantifying leak-based signatures. The disclosed system can detect micro-leaks and generates substantially no false positives.

### CROSS REFERENCE TO RELATED APPLICATIONS

This application claims the benefit of U.S. Provisional Application No. 63/461,955 filed on Apr. 26, 2023, which is incorporated herein by reference in its entirety.

### STATEMENT REGARDING FEDERALLY SPONSORED RESEARCH OR DEVELOPMENT

This invention was made with government support under grant number DE-SC0021366 awarded by the Department of Energy. The government has certain rights in the invention.

### BACKGROUND

Leak detection for both oil and gas pipelines as well as storage tanks plays a significant role in preventing the contamination of the environment. Conventional sensors and gauges only measure at discrete locations, which makes it difficult to monitor over large areas such as entire pipeline networks. Very small leak rates may not be detected and localized using conventional sensors due to their poor sensitivity. Fiber optic sensing-based leak detection is gaining more attention due to its smaller footprint, immunity to electromagnetic interference and resistance to corrosion. However, most commercially available solutions fall into one of the following categories: (1) internally based systems, which use field instrumentation such as flow, pressure, or fluid temperature sensors to monitor internal pipeline parameters or (2) externally based systems, which use field instrumentation to monitor external pipeline parameters such as, for example, fiber-optic cables, infrared radiometers or thermal cameras, vapor sensors, and acoustic microphones.

The performance of pipeline leakage detection methods generally varies depending on the approaches, operational conditions, and pipeline networks. However, guidelines set by the American Petroleum Institute in RP-1175 for parameters such as sensitivity, accuracy, reliability and adaptability must be met for any leak detection system. Based on a review of existing commercial leak detection technologies, it can be concluded that it is difficult to demonstrate a successful system applicable in both subsea and surface applications. One major limitation is low sensitivity to detect very small leakage in a timely manner; current technologies can detect leak rates down to ~1-5% of flow volume, which can miss micro-leaks that accrue over time. Another major limitation is the inability to reliably distinguish leak from environmental/background noise resulting in false positives. Finally, known leak-detection systems have a low signal-to-noise ratio, especially in long distance deployment over several kilometers, due to optical losses.

Despite advances in leak detection research, there is still a scarcity of methods for leak detection that are functional in both surface and subsea applications, that will detect micro-leaks, that have a high signal-to-noise ratio, and that do not produce a significant number of false positives. These needs and other needs are satisfied by the present disclosure.

### SUMMARY

In accordance with the purpose(s) of the present disclosure, as embodied and broadly described herein, the disclosure, in one aspect, relates to a system and method for detecting leaks in fluid handling systems, including, but not limited to, wells, pipelines, and storage tanks for natural gas and petroleum products. In another aspect, the system includes one or more optical fiber sensors having fiber Bragg gratings (FBGs) wherein a perturbation of the system causes a reflected wavelength shift. In the disclosed method, data collected from the FBG-containing sensors is detrended using a non-linear detrending algorithm after subtracting a synthetic baseline from raw data, thereby extracting and quantifying leak-based signatures. The disclosed system can detect micro-leaks and generates substantially no false positives.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a schematic of an exemplary FBG sensing method according to the present disclosure.

FIG. 2 shows raw wavelength shifts of FBGs as a function of time. 1556 nm FBG is pasted nearer to the leak port.

FIGS. 3A-3B show non-linear detrending of (FIG. 3A) 1556 nm and (FIG. 3B) 1550 nm FBG data. 1556 nm FBG is pasted nearer to the leak.

FIG. 4 shows maximum shift in FBG wavelength as a function of leak rate. Data is fitted with first order polynomial.

FIG. 5 is a photograph of a leak simulation flow loop instrument with FBG and SM fiber for DAS acquisition.

FIG. 6A shows results from leak monitoring tests using DAS FBE 200-500 Hz. FIG. 6B shows relationship between FBE amplitude and leak rate.

FIG. 7A shows results from leak monitoring tests using two FBGs. FIG. 7B shows the relationship between the wavelength shift and leak rate (an exemplary correlation for non-linear detrending of collected leak data).

FIG. 8 shows an exemplary distributed acoustic sensor (DAS) useful for leak detection.

FIG. 9 shows an exemplary method for using a fiber Bragg grating (FBG) for leak detection.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein are a system and method for leak detection and quantification of very small leak rates (or microleaks) using a Fiber Bragg Grating (FBG) sensing scheme. The disclosed method is computationally-inexpensive and capable of real time extraction of fluid signatures from noisy data. In one aspect, FBG incorporated into optical fibers are advantageous since they are lightweight, chemically passive, immune to electromagnetic influence, and do not require electronics along the optical path.

In one aspect, in the present case, laser pulses can be sent into an optical fiber, and the backscattered light signals are used to detect changes in physical parameters. In an aspect, these sensors have the benefit of providing spatially and temporally continuous information with a single lead cable without the need for any electronics at the sensed location. In a further aspect, the fiber functions both as a sensor as well as a low-loss, high-speed conduit for data providing simultaneous measurement at high spatial resolution along the entire length of the pipeline. In one aspect, optical fibers' small size (<1 cm outer diameter), lightweight (therefore, fast response time), low data losses, and form factor versatility enable relatively easy installation on several kilometers of surface, subsurface, and subsea pipelines, with minimal disruption to flow. In another aspect, since the sensing modality is based on optical modulation and the sensed information is carried using light, fiber-optic sensors enable both more precise localization and detection of signals, such as small leaks that often go undetected by conventional gauges.

In one aspect, the implementation of sensors into pipelines for the purpose of leak detection is only as beneficial as their ability to successfully detect leaks while minimizing false alarms. In a further aspect, for sensors to detect small leaks, they must be sensitive to small changes in the environment. However, high sensitivity leaves sensors vulnerable to noise that can resemble or become indistinguishable from the small leak signals. In any of these aspects, a simple threshold will not be robust enough to be useful in this situation due to the inherent variability in signal and noise intensities for different operational and environmental conditions. In a further aspect, a threshold too high will miss small leaks that are often too difficult for traditional methods, whereas a threshold too low will be sensitive to noise and cause too many false alarms to be relied upon. In a still further aspect, the implementation must be realistic and cost-effective.

In one aspect, the disclosed method is a method for detecting a leak in a component of a system for handling a fluid, the method including at least the steps of:
(a) generating a signal by sensing one or more physical parameters using one or more sensors, wherein the one or more sensors include optical fibers having fiber Bragg gratings (FBG);
(b) electronically converting the signal to data, wherein the data includes at least raw FBG wavelength shift data; and
(c) performing detrending on the data to generate detrended data.

In another aspect, the detrending is non-linear detrending and can include at least the following:
(a) selecting an optimum filter window size;
(b) deploying a moving average filter to generate a synthetic baseline; and
(c) subtracting the synthetic baseline from the raw FBG wavelength shift data;
wherein step (c) extracts leak-induced signatures.

In another aspect, the FBG can be a 1556 nm FBG, a 1550 nm FBG, or the method can include using both a 1556 nm FBG and a 1550 nm FBG. In any of these aspects, the FBG can have a grating length of about 1 cm and can have a full width at half maximum (FWHM) response of about 0.2 mm. In one aspect, the method uses a first optical fiber having a first FBG and a second optical fiber having a second FBG, wherein at least one of the first FBG or the second FBG is exposed to leak conditions, while the other is not, and wherein a comparison between signals and/or data from the leak-exposed FBG and the non-leak-exposed FBG is made in order to gain more information about the size of the leak, the location of the leak, the rate of the leak, or any combination thereof. In some aspects, the method can make use of data and/or signals from more than two FBG at different portions of the fluid handling system, such as three, four, five, six, or more FBG, wherein at least one FBG is exposed to leak conditions and at least one FBG is not exposed to leak conditions.

In one aspect, the fluid can be crude petroleum, refined petroleum, natural gas, or any combination thereof. In still another aspect, the component of the fluid handling system can be a well, a pipeline, a storage tank, another storage structure, a transport structure, or any combination thereof. In any of these aspects, the component of the fluid handling system can be undersea or on land, whereas land-based systems can include surface and/or subsurface components.

In one aspect, the method further includes quantifying the leak, wherein quantifying the leak includes at least the steps of:
(a) processing the detrended data using one or more of frequency band energy (FBE), root mean square (RMS), envelope fit using Hilbert transform, and moving sum filter to generate processed data; and
(b) correlating the processed data to one or more known values for a leak rate in order to quantify the leak.

In one aspect, all four data processing options from step (a) are used sequentially in the order listed. In any of these aspects, the method is capable of detecting a leak of less than 5% of flow volume, or of less than or equal to about 1% of flow volume, or of less than about 0.1 gallons per minute. In another aspect, the method is substantially free from generating false positives.

Also disclosed herein is a system for detecting a location of a leak in a component of an apparatus for handling a fluid, the system including at least the following parts:
(a) one or more sensors including optical fibers, wherein the optical fibers include fiber Bragg gratings (FBG) for the sensing of one or more physical parameters in the component of the apparatus for handling a fluid;
(b) a detection module for receiving signal data from the one or more sensors; and
(c) a computation module for detrending the signal data according to the disclosed method.

In an aspect, the optical fiber can be an axial fiber or a helical fiber. In another aspect, the optical fiber can be a single-mode optical fiber or a multi-mode optical fiber.

In any of these aspects, the one or more physical parameters can be temperature, pressure, vibration, strain, or any combination thereof. In a further aspect, the signal data results from reflected wavelength from the FBG in response to physical parameter measurements.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a pipeline,” “a port,” or “an optical fiber,” includes, but is not limited to, mixtures, combinations, or series of two or more such pipelines, ports, or optical fibers, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

A “micro-leak” as used herein refers to a leak of a fluid such as, for example, crude petroleum, refined petroleum, or natural gas, where the leak is too small to be detected by conventional leak detection equipment. A micro-leak can be, for example, less than or equal to about 1% of flow volume or flow rate through a pipeline component, or less than 0.1 gallons per minute from a stationary component such as a storage tank or other storage structure.

A “fiber Bragg grating” (FBG) refers to a type of a distributed Bragg reflector made or attached to a short segment of optical fiber. The FBG reflects a particular wavelength of light (e.g. 1556 nm or 1550 nm) and transmits all others. In one aspect, the system and method disclosed herein use optical fibers having FBGs to detect and quantify leaks in petroleum and natural gas handling systems.

“Detrending” as used herein refers to a mathematical process conducted on raw data to remove long-term trends from the data. Detrending allows observation of subtrends or features of data streams that might not otherwise be observable. In one aspect, detrending raw data as described herein allows for detection and quantification of micro-leaks.

“Full width at half maximum” or FWHM is a statistical measure used to describe the width of a normal distribution or Gaussian distribution. Specifically, it represents the width of a curve measured between the two points where the curve's value is half its maximum.

“Frequency band energy” or FBE as used herein is obtained by calculating the cumulative energy of the signal in the frequency domain for a fixed time duration and specific frequency range for a given signal such to isolate the useful signals from the background noise. FBE is a powerful signal processing technique that not only reduces the data storge space but also reduces the noise by filtering the desired frequency range. Fast Fourier transform (FFT) is applied to the time-series data, and the resultant magnitude is denoted as H∈ [symbol] where D and F are the same numbers of samples in Q, but in the space and frequency dimension. Then FBE is calculated according to the following equation where ƒl, and ƒh are lower and higher cut-off frequencies of the selected frequency band range. Subsequently FBE is calculated for all the K time frames and the resultant is denoted as FBE^{[ƒl-ƒh]}∈

[symbol]

$$G = {\sum }_{i = {f}_{l}}^{{f}_{h}} {H}_{di}^{2} ∈ {ℝ}^{DX 1}$$

“Mean” or “moving average mean” as used herein refers to a mathematical technique for signal averaging, which can assist in reducing noise without compromising important experimental details. In one non-limiting example, a moving average mean for raw DAS strain rate or vibration data can be calculated according to the following equation, but it is to be understood that moving averages for other inputs can be calculated in an analogous manner: raw DAS strain rate or vibration data is expressed as K time frames and each time frame represented as Q∈ [symbol] DXT, where D and T are the numbers of the samples in the space and time dimensions, respectively. Mean is computed on each time frame and the computed mean across all the K time frames is stored as a single matrix as

$${M}^{DXK} A = \frac{{\sum }_{i = 1}^{T} {Q}_{dt}}{T} ∈ {ℝ}^{DX 1}$$

In another aspect, “standard deviation” can be used herein. Standard deviation is another computationally inexpensive technique that can help in enhancing the signal-to-noise-ratio (SNR), especially for dynamic processes. Standard deviation of each time frame is computed using the following equation. This can be calculated for all the time frames and appended as STD^{DXK}.

$${S}_{DX 1} = \sqrt{\frac{1}{T - 1} {\sum }_{i = 1}^{T} {\vert {Q}_{dl} - {A}_{d} \vert}^{2}}$$

As used herein, “root mean square” or RMS of a set of numbers (e.g. wavelength shift data from an FBG) is the square root of the set's mean square. In one aspect, for leak quantification, the RMS of the FBG wavelength shift is plotted as a function of the leak rate as part of the non-linear detrending algorithm disclosed herein to reduce background noise. RMS can be derived using the following equation and the resulting outcomes of different time frames can be stored in a single matrix as RMS^{DXK}. This method can help in smoothing out rapidly changing signals, such as noise.

$$R = \sqrt{\frac{{\sum }_{i = 1}^{T} {\vert {Q}_{di} \vert}^{2}}{T}} ∈ {ℝ}^{DX 1}$$

“Envelope fit using Hilbert transform” is an analysis technique involving the envelope of an input signal (equivalent to the outline of the signal). A complex analytic signal of the input signal is generated using the Hilbert transform, where the complex analytic signal includes a real part (the original input signal) and an imaginary part (the Hilbert transform of the original signal).

A “moving sum filter” is an analysis technique producing an array of local sums, where each sum is calculated over a sliding window of a given length across a specified number of local elements.

In another aspect, “Fourier space filtering” can be used to address issues related to undesired horizontal or vertical bands in a processed signal. Implementation of averaging or filtering can sometimes result in undesired horizontal or vertical bands in the processed signal. These bands may also be present inherently present in fiber-optic sensor data due to the non-uniform fiber coupling. One method to remove these is using 2D-FFT filtering. Consider the processed data using the above-mentioned techniques be denoted as C∈ [symbol] . This data matrix can be converted into Fourier space using 2D-FFT and labeled as E∈ [symbol] , where W and Y are same number of elements in Fourier space as D and K. The frequency components which contribute to the noisy bands (such as the DC components which are close to the origin) can then be replaced with zeros and transformed back to space and time domain.

In still another aspect, a “gradient filter” computes the gradient depending on the appearance of the bands. If the noisy bands are on the time axis of C, then the gradient with respect to time is computed as shown in the equation below and labeled as P∈ [symbol] . If noisy bands are dominant in the depth axis, gradient is computed using the following equation, but in-depth direction and labeled as P∈ [symbol] .

$${P}_{d , i - 1} = {C}_{d , i} - {C}_{d , i - 1} ∀ i = 2 , 3 , 4 … , K$$

In yet another aspect, “gradient-based iterative destriping algorithm” or “GBDIA” can be used to process the data. In this technique, a gradient mask is used to filter the noisy image or data matrix in the Fourier space by doing element wise matrix multiplication with the generated gradient mask. The data is then converted back to the space and time domain. GBDIA has been deployed for successfully destriping satellite images. Gradient mask is generated by first creating a matrix called TEMP∈ [symbol] using the following equations. The matrix is then flipped horizontally and appended to its original as shown in the following equations and labeled 192 as FI∈

[symbol]

$${TEMP}_{ij} = \frac{( j - 1 )}{K} ∈ {ℝ}^{DX \frac{K}{2}}$$

where i=1, 2, 3, . . . D and j=1, 2, 3, . . . K/2.

$$FI = [ TEMP {TEMP}_{d ( \frac{K}{2} 1 + j )} ] ∈ {ℝ}^{DXK}$$

where j=1, 2, 3, . . . K/2

A new matrix WI ∈ [symbol] is created by implementing the above equations but in the column direction. Then the gradient mask is computed using the following equations where tol ∈ [symbol] is a tuning parameter.

$$GM = [ \frac{FI ⊙ FI}{( FI ⊙ FI ) + ( WI ⊙ WI ) + tol} ] ∈ {ℝ}^{DXK}$$

$$GM ( GM > tol ) = tol$$

Here GM is computed by assuming noisy bands are in the horizontal direction. If noisy components are in vertical direction, the above equation can be written as:

$$GM = [ \frac{WI ⊙ WI}{( FI ⊙ FI ) + ( WI ⊙ WI ) + tol} ] ∈ {ℝ}^{DXK}$$

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.
Aspect 1. A method for detecting a leak in a component of a system for handling a fluid, the method comprising:
(a) generating a signal by sensing one or more physical parameters using one or more sensors, wherein the one or more sensors comprise optical fibers comprising fiber Bragg gratings (FBG);
(b) electronically converting the signal to data, wherein the data comprises raw FBG wavelength shift data; and
(c) performing detrending on the data to generate detrended data.
Aspect 2. The method of aspect 1, wherein the detrending is non-linear detrending and wherein the parameters of the non-linear detrending are customized to a signal of interest.
Aspect 3. The method of aspect 1 or 2, wherein preforming detrending on the data comprises:
(a) selecting an optimum filter window size;
(b) deploying a moving average filter to generate a synthetic baseline; and
(c) subtracting the synthetic baseline from the raw FBG wavelength shift data from a central wavelength; wherein step (c) extracts leak-induced signatures.
Aspect 4. The method of any one of aspects 1-3, wherein the one or more sensors comprise a first optical fiber comprising a first FBG and a second optical fiber comprising a second FBG.
Aspect 5. The method of aspect 4, wherein the first FBG is affected by the leak and the second FBG is not affected by the leak, and wherein the method further comprises comparing a signal from the first FBG to a signal from the second FBG.
Aspect 6. The method of any one of aspects 1-5, further comprising performing one or more additional signal processing techniques for noise reduction.
Aspect 7. The method of any one of aspects 1-6, wherein the fluid comprises water, crude petroleum, refined petroleum, natural gas, or any combination thereof.
Aspect 8. The method of any one of aspects 1-7, wherein the component comprises a well, a pipeline, a storage tank, another storage structure, a transport structure, or any combination thereof.
Aspect 9. The method of any one of aspects 1-8, wherein the component is undersea, at a land surface, or is a subsurface component on land.
Aspect 10. The method of any one of aspects 1-9, the method further comprising quantifying the leak, wherein quantifying the leak comprises:
(a) processing the detrended data using one or more of frequency band energy (FBE), root mean square (RMS), envelope fit using Hilbert transform, and moving sum filter to generate processed data; and
(b) correlating the processed data to one or more known values for a leak rate in order to quantify the leak.
Aspect 11. The method of any one of aspects 1-10, wherein the method is capable of detecting a leak of less than 5% of flow volume.
Aspect 12. The method of any one of aspects 1-11, wherein the method is capable of detecting a leak of less than or equal to about 1% of flow volume.
Aspect 13. The method of any one of aspects 1-12, wherein the method is capable of detecting a leak rate less than 0.1 gallons per minute.
Aspect 14. The method of any one of aspects 1-13, wherein the method is substantially free from generating false positives.
Aspect 15. A system for detecting a location of a leak in a component of an apparatus for handling a fluid, the system comprising:
(a) one or more sensors comprising optical fibers, wherein the optical fibers comprise fiber Bragg gratings (FBG) for the sensing of one or more physical parameters in the component of the apparatus for handling a fluid;
(b) a detection module for receiving signal data from the one or more sensors; and
(c) a computation module for detrending the signal data according to the method of any one of aspects 1-14.
Aspect 16. The system of aspect 15, wherein the optical fiber is an axial fiber or a helical fiber.
Aspect 17. The system of aspect 15 or 16, wherein the optical fiber is a single-mode optical fiber or a multi-mode optical fiber.
Aspect 18. The system of any one of aspects 15-17, wherein the one or more sensors comprise a first optical fiber comprising a first FBG and a second optical fiber comprising a second FBG.
Aspect 19. The system of any one of aspects 15-28, wherein the fluid comprises water, crude petroleum, refined petroleum, natural gas, or any combination thereof.
Aspect 20. The system of any one of aspects 15-19, wherein the component comprises a well, a pipeline, a storage tank, another storage structure, a transport structure, or any combination thereof.
Aspect 21. The system of any one of aspects 15-20, wherein the one or more physical parameters comprise temperature, pressure, vibration, strain, or any combination thereof.
Aspect 22. The system of any one of aspects 15-21, wherein the signal data results from reflected wavelength from the FBG in response to physical parameter measurements.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Development of FBG Technology

The disclosed leak detection system and method addresses the major limitations of current technology through the use of optimized detection strategies using FBG. Out of the existing commercial leak detection technologies presented in Table 1, fiber optic sensors offer many advantages, however, there are still some limitations which are addressed herein. Among other things, fiber optic sensing is insensitive to electromagnetic noise with the additional advantage that the optical fiber functions both as the sensor and the channel to transmit the data. These sensors are capable of measuring physical properties such as temperature, pressure, vibration, and strain variations. As a result, they are ideally suited for borehole environments and pipelines due to their non-intrusive installation and are thus ideal for natural gas and oil reservoir and surface infrastructure monitoring.

TABLE 1
Comparison of Select Leak Detection Technologies Used in the Oil and Gas Industry

| Methods | Principle of Operation | Strengths | Weaknesses |
|---|---|---|---|
| Acoustic Emission | Detect leaks by picking up | Easy to install and suitable | Sensitive to random and |
| | intrinsic signals escaping | for early detection, portable | environmental noise, prone to |
| | from a perforated pipeline. | and cost-effective. | false alarms and not suitable |
| | | | for small leaks. |
| Fiber Optics | Detect leaks through the | Insensitive to | The cost of implementation is |
| Sensing | identification of temperature | electromagnetic noise and | high, not durable and not |
| | changes in the optical | the optical fiber can act both | applicable for pipelines |
| | property of the cable induced | as sensor and data | protected by cathodic |
| | by the presence of leakage | transmission medium. | protection systems. |
| Vapor Sampling | Utilize hydrocarbon vapor | Suitable for detecting small | Time taken to detect a leak is |
| | diffused into the sensor tube | concentrations of diffused | long, not really effective for |
| | to detect trace | gas | subsea pipelines. |
| | concentrations of specific | | |
| | hydrocarbon compounds. | | |
| Infrared | Detect leaks using infrared | Highly efficient power for | Quantifying leak orifices |
| Thermography | image techniques for | transforming detected | smaller than 10 mm using |
| | detecting temperature | objects into visual images, | IRT-based systems is difficult. |
| | variations in the pipeline | easy to use and fast | |
| | environment. | response time | |
| Ground | Utilize electromagnetic | Timely detection of leakage | GPR signals can easily be |
| Penetration Radar | waves transmitted into the | in underground pipelines, | distorted in a clay soil |
| | monitoring object by means | reliable and leak information | environment, costly and |
| | of moving an antenna along a | is comprehensive. | require highly skilled operator |
| | surface. | | |
| Fluorescence | Proportionality between the | High spatial coverage, quick | Medium to be detected must |
| | amount of fluid discharged | and easy scanning for leaks. | be naturally fluorescent |
| | and rate of light emitted at a | | |
| | different wavelength | | |
| Electromechanical | Utilize mechanical | A single piezoelectric | It is only applicable for metal |
| Impedance | impedance changes | transducer can serve as both | pipelines, operational |
| | deduced by the incident of | sensor and actuator | limitations in high temperature |
| | pipeline defect | | environments. |
| Capacitive | Measuring changes in the | It can be employed for | Requires direct contact with |
| Sensing | dielectric constant of the | detection in non-metallic | the leaking medium. |
| | medium surrounding the | targets. | |
| | sensor. | | |
| Spectral Scanners | Comparing spectral | Capable of identification of oil | The amount of data generated |
| | signature against normal | type (light crude) and | by a spectral scanner is large |
| | background. | thickness of the oil slick. | which limited its ability to |
| | | | operate in nearly real-time. |
| Lidar Systems | Employed pulsed laser as the | Able to detect leaks in the | High cost of execution and |
| | illumination source for | absence of temperature | false alarm rate. |
| | methane detection. Measure | variation between the gas | |
| | emitted energy at different | and the surroundings | |
| | wavelengths. | | |
| Electromagnetic | Utilize hydrocarbon vapor | It can indicate leak location | It can be affected by severe |
| Reflection | diffused into the sensor tube | | weather. |
| | to detect trace | | |
| | concentrations of specific | | |
| | hydrocarbon compounds. | | |

FBG-based sensors are widely utilized in the field of sensing due to their wavelength-encoded information, flexibility, smaller footprint, and lower cost compared to traditional sensors. Nevertheless, FBGs are susceptible to strain, temperature, and pressure variations. When placed deployed on a pipeline, FBGs are additionally affected by environmental factors like heat, wind, and precipitation. So, a computationally cheap approach is needed to detect just the changes caused by leaks.

### Technical Details

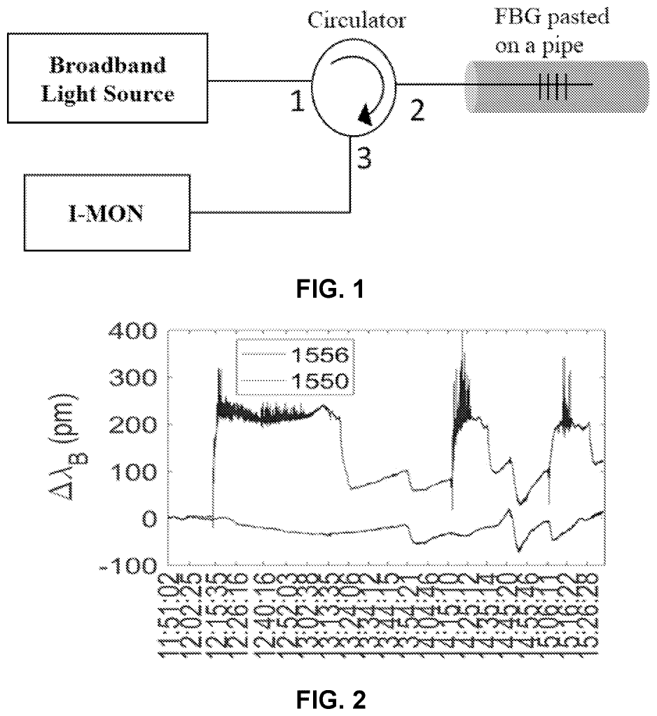

A typical FBG sensing configuration is shown in FIG. 1. Broadband light source, FBG and spectrometer are connected to Port 1, Port 2 and Port 3 of the optical circulator. FBG is surface mounted and is illuminated by a broadband source, reflections due to Bragg gratings in the Port 2 are fed to the spectrometer which is connected in Port 3. When FBG detects any change in surrounding environment like strain/temperature, it picks up in terms of change in Bragg wavelength and can be seen or recorded on the spectrometer. When the leak is created, there will be a dynamic strain and/or a temperature effect generated due to the fluid interaction with the pipe/environment. Those perturbations can be detected using FBGs.

Nevertheless, when FBGs are utilized for leak detection, there is a considerable likelihood that they may respond to false alarms caused by wind, fluid transfer, rain, or sunlight, etc. As stated previously, it is sensitive to both changes in temperature and strain, and it is difficult to separate them. FIG. 2 displays a sample FBG data set. 1556 nm FBG is placed near a leak port, while another is pasted distant from it. For different situations, both responses are recorded. X and Y axis indicate the time and wavelength shift. It is observed that FBGs are very susceptible to fluid transfer, which makes it challenging to locate the leak instants. Thus, a method that is only sensitive to leaks was developed. As a result, innovators devised a simple, computationally inexpensive method for extracting sensitive information that is vulnerable to leaks.

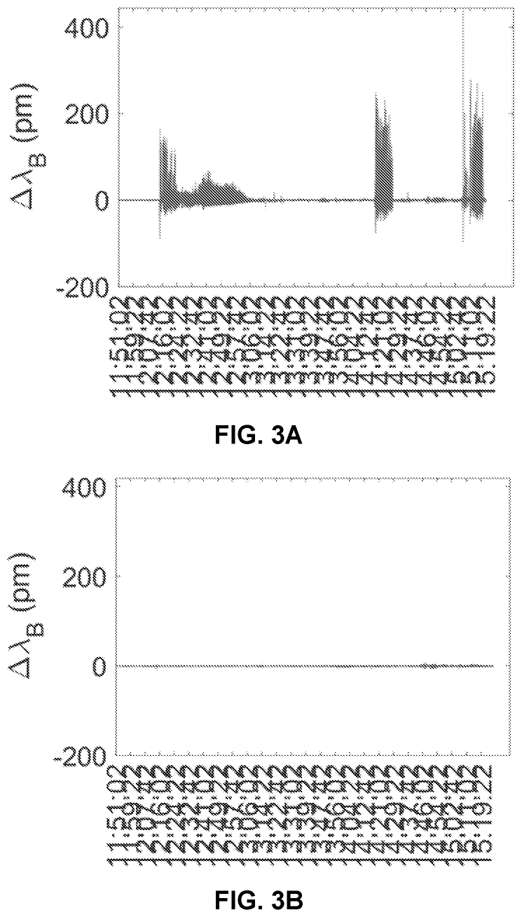

Due to ambient circumstances, the FBG wavelength trend is nonlinear, necessitating the application of a unique detrending approach. Disclosed herein is a novel method that requires no domain transformation and may be implemented directly on FPGA or on-board circuits with little processing effort. The approach proposed herein is called non-linear detrending. The suggested method detrends the data and extracts the leak-only characteristics. FIGS. 3A-3B depict the outcome of adopting nonlinear detrending. The FBG closest to the leak can extract the leak characteristics while suppressing extraneous events such as wind, fluid transfer, and the like.

Non-linear detrending steps useful in the disclosed methods include smoothing the raw wavelength shift data using a moving average filter with an optimum window size and then subtracting the smoothed data from the raw wavelength shift data.

### Leak Quantification

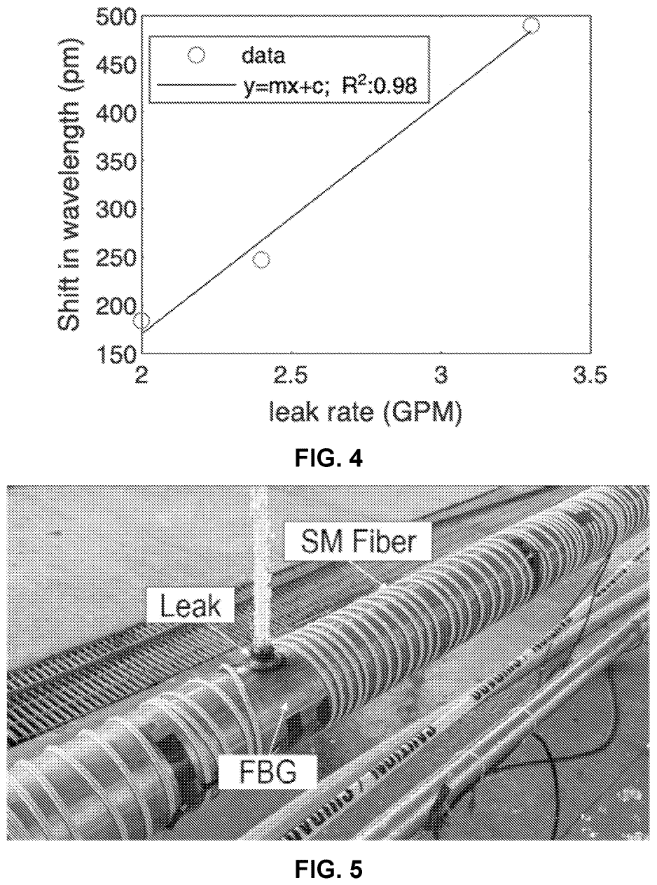

To quantify the leak rate, envelopes are fitted to the detrended data, and the amplitude information is extracted. Then maximum shift in wavelength is plotted as a function of the leak rate as shown in FIG. 4 is fitted with first order polynomial and obtained a decent R² of 0 0.98.

### Example 2: Comparison of Distributed Acoustic Sensors (DAS) and FBGs for Leak Detection

Real-time leak monitoring and early leak detection are critical for preventing environmental contamination. Conventional sensors, like pressure gauges, offer a simple and cost-effective solution for detecting large leaks. However, smaller leak rates often go undetected using conventional gauges due to their limited sensitivity. Leak localization is another challenge with conventional point-sensors as they only provide measurements at discrete locations. Optical fiber-based sensors can address the shortcomings of conventional gauges owing to their high sensitivity as compared to typical mechanical systems and their ability to provide fully-distributed or quasi-distributed measurements simultaneously along the length of the fiber. They also offer additional advantages, including their small size and lightweight, resulting in quick response time, immunity to electromagnetic interference, ability to easily retrofit them on structures, resistance to corrosion, and ability to provide measurement without any electronics at the sensed location.

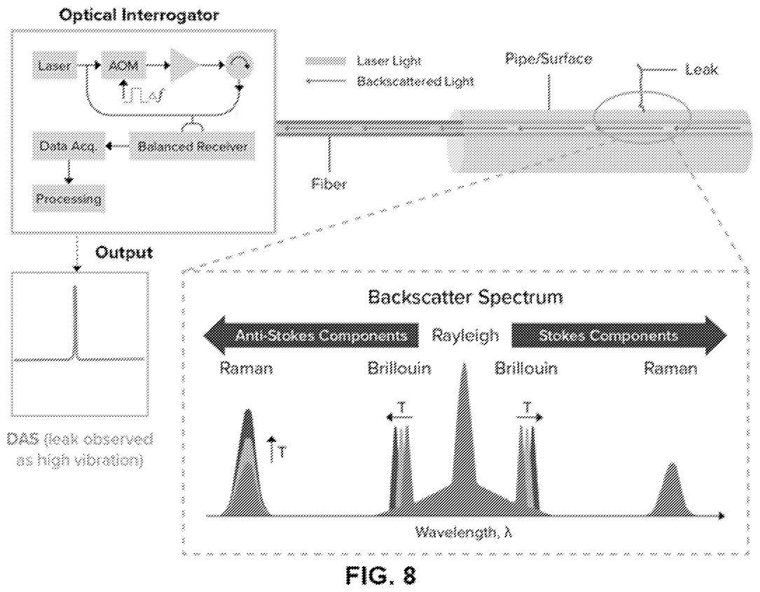

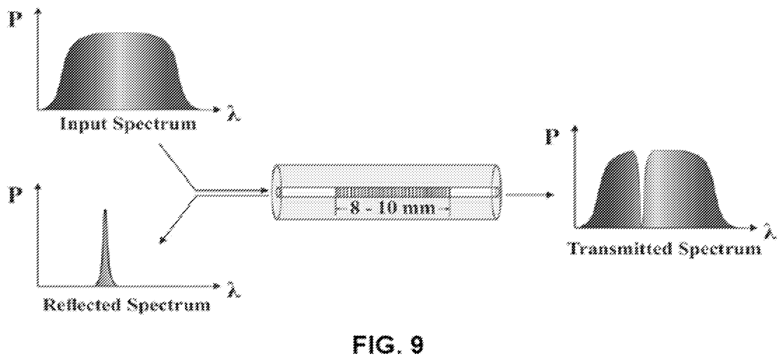

In this study, two commonly used optical sensing schemes are experimentally investigated and compared for leak detection applications: distributed acoustic sensors (DAS) (FIG. 8) and fiber Bragg gratings (FIG. 9). The goal was to experimentally evaluate their ability to detect and quantify leaks at different flow conditions. Every sensing scheme has its own advantages and disadvantages. DAS provides fully distributed measurements along the fiber, whereas FBG provides quasi-distributed sensing, although at higher signal intensity. DAS systems also require larger data storage space than FBG and they are also typically more expensive than FBG systems5. While these differences may influence the sensor selection for a particular application, this study primarily focuses on the sensitivity of leak detection and quantification.

### Experimental Set-Up and Methodology

Leak experiments with water were conducted using a flow loop consisting of a 20 ft long stainless-steel pipe of 4-in outer diameter. A standard single mode (SM) telecom optical fiber with a plastic outer jacket was helically wrapped around the pipe with an average pitch of 1 in, as shown in FIG. 5. The effective length of the fiber around the flow loop was 350 ft. Two FBGs were axially surface mounted on the outer pipe wall. One was pasted at the leak port and the other 4 ft away to compare the signals. Leaks were simulated through a machined leak port on the main pipe, as shown in FIG. 5. Table 2 summarizes the different main pipe flow rates and the corresponding leak rates that were measured manually. The leaks with the pump-off were created by using the hydrostatic pressure differential between the water tank (used for circulating the water) and the pipe. The same test matrix was used for both the DAS and FBG sensors. The different leak rates are resulting from the slightly different pressure conditions during the two tests.

TABLE 2
Test Matrix for Flow Loop Leak Tests

| Pump | Leak rate | Leak rate |
|---|---|---|
| flow | during DAS | during FBG |
| rate | experiments | experiments |
| (gpm) | (gpm) | (gpm) |
| 0 (pump off) | 0.07 to 1.67 | 0.07 to 2.1 |
| 10 | 2.2 | 2.4 |
| 20 | 4.5 | 3.3 |
| 30 | 6.0 | 4.3 |

For DAS acquisition, a commercially available optical interrogator was used that derives the optical phase from the signal by combining the Rayleigh backscattered light from the SM fiber with a local oscillator in a heterodyne process. For the FBG tests a commercially available broadband source, CCD based spectrometer, and two FBGs were used. The acquisition parameters for DAS and FBG are tabulated in Table 3.

TABLE 3
Acquisition Parameters for DAS and FBG

| DAS | | | FBG | | |
|---|---|---|---|---|---|
| Optical mode | Single-mode | | Optical mode | Single-mode | |
| Spatial resolution | 4.92 | ft | Spatial resolution | ~4 | ft |
| Sampling interval | 2.53 | ft | Central wavelength | 1556 and 1550 | nm |
| Temporal resolution | 0.0001 | sec | FWHM | 0.2 | mm |
| Range | 16 | km | Grating length | ~1 | cm |
| Frequency | 10 | kHz | Frequency | 1 | kHz |

| | | | | |
|---|---|---|---|---|
| Gauge length | 4.92 | ft | Interrogator | CCD element-based |

spectrometer

### Results and Discussion

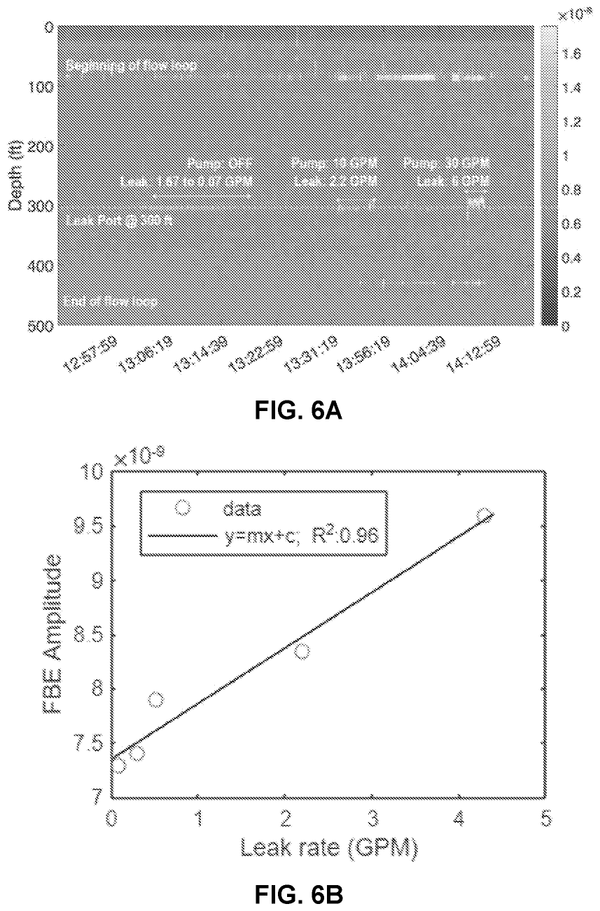

Leak Detection and Quantification Using DAS. The DAS vibration data consists of a significant amount of background noise, which limits the scope of leak detection with confidence. In general, DAS generates large amounts of streaming data (on the order of terabytes per hour), which poses data transmission, processing, interpretation, storage, and archival challenges. To overcome this, the time-domain vibration data was processed to get frequency band energy (FBE). FBE is obtained by calculating the cumulative energy of the signal in the frequency domain for a fixed time duration and specific frequency range to isolate the useful signals from the background noise. For the tests analyzed, the optimum FBE frequency range was derived as 200-500 Hz, which is plotted as a function of depth and time in FIG. 6A, for different leak rates and flow conditions. The results show that the leak events can be localized at ~300 ft, which is the location of the leak port. The FBE intensity corresponding to the leak rate can be used to quantify the leak rate, as shown in FIG. 6B.

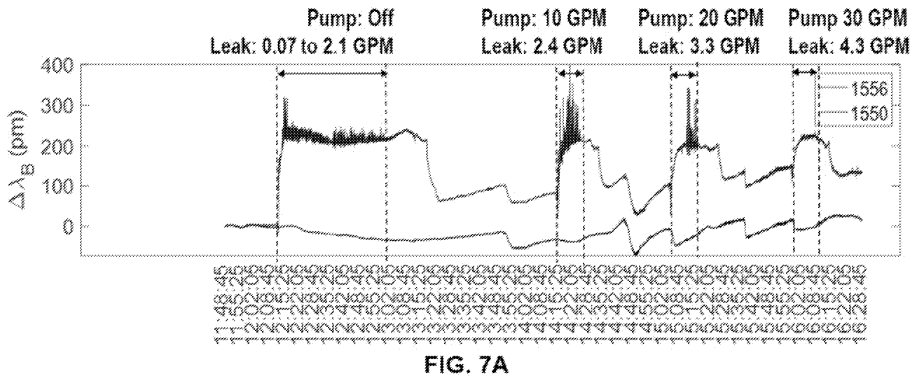

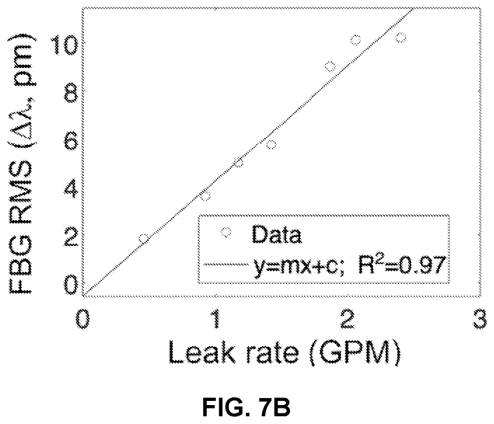

Leak Detection and Quantification Using FBG. For this study, two FBGs were utilized: an FBG with a central wavelength of 1556 nm was axially surface mounted at the leak port, and another FBG with a central wavelength of 1550 nm was pasted 4 ft away from the leak port. The goal was to compare the FBG responses at the leak location and away from it. The same test matrix was repeated for the FBG experiments (Table 2). The shift in wavelength data during the experiments is shown in FIG. 7A. FBGs are sensitive to ambient temperature and vibration signals, as can be noticed in FIG. 7A. This can make it difficult to detect the leak signal from the dynamic background effects with confidence. Therefore, an advanced signal processing technique was developed and deployed to avoid false leak alarms. After deploying the algorithm, the leak signatures can be easily identified, in spite of the background variations. For leak quantification, the root mean square (RMS) of the FBG wavelength shift is plotted as a function of the leak rate, which demonstrates a reasonable correlation with a first-order linear fit, as shown in FIG. 7B.

### Conclusion

This study presents the application of DAS and FBG for pipeline leak detection and quantification. The results from the flow loop experiments demonstrate the ability to detect leak rates as low as 0.07 gpm using DAS and FBG. A variety of signal processing techniques were utilized to enhance the ability to detect leaks from dynamic background noise. The ability to quantify the leak rate was demonstrated using the FBE amplitude for DAS and the wavelength shift followed by a detrending algorithm, for the FBG case.

### Example 3: Non-Linear Detrending Algorithm

Fiber Bragg grating (FBG)-based leak detection signals may encounter non-linearity due to false alarms as well as ambience and optoelectronic noise. To isolate the leak signatures from background signals to detect leaks with high confidence and minimize false leak alarms a computationally-inexpensive algorithm called non-linear detrending is deployed. The algorithm involves a two-part procedure for leak detection and leak quantification as follows.

### Part 1: Leak Detection Using FBG

The following procedure can be used for leak detection using FBG:
1. Select the optimum filter window size.
2. Deploy a moving average filter to generate a synthetic baseline.
3. Subtract the synthetic baseline from raw FBG wavelength shift data to extract the leak-induced signatures.

### Part 2: Leak Quantification

The following procedure can be used for leak quantification after leak detection:
4. Process the detrended FBG data using the following independent techniques:
   a. Frequency band energy (FBE)
   b. Root mean square (RMS)
   c. Envelope fit using Hilbert transform.
   d. Moving sum filter
5. Generate correlations that map the above signal amplitudes with one or more known leak rates to derive a correlation function.

Exemplary MATLAB code for Parts 1 and 2 is presented in Table 4.

TABLE 4
MATLAB Code for Non-Linear Detrending Algorithm

Matlab code for Part 1

| | |
|---|---|
| Line 01: | A= movmean(Raw,windowsize); |
| Line02: | B=Raw−A; |

Line 1 generates a synthetic baseline using moving average filter with an optimum widow size
(windowsize). Here Raw consists of an array of shifts in wavelength data.
Line 2 extracts the feature associated to the leak and suppresses the false alarms due to the
fluid flow and spurious responses etc. And store in variable B
Matlab code for part 2
4a) Frequency band energy

| | |
|---|---|
| Line 03a: | freq_st= [0 2 10 50 200 500]; |
| Line 04a: | freq_en = [2000 10 50 200 500 1000]; |
| Line 05a: | fs=1000; % Acquisition frequency |
| Line 06a: | frame_length=10; % in seconds |
| Line 07a: | frame_size = frame_length * fs; |
| Line 08a: | frame_counter = 0; |
| Line 09a: | for frame_idx = 1 : 1: floor(nb_frames_per_file) |
| Line 10a: | st_index = (frame_idx − 1)*frame_size + 1; |
| Line 11a: | end_index = st_index + frame_size − 1; |
| Line 12a: | Data = B(st_index:end_index); |
| Line 13a: | frame_counter = frame_counter + 1; |
| Line 14a: | Time_Array(frame_counter) = datenum(time_vec) + datenum([0 0 0 0 0 |
| frame_length*( | frame_idx−1)]); |
| Line 15a: | nfft = 2\hat{ }nextpow2(size(Data,2)); |
| Line 16a: | Data_Spectrum = abs(fft(Data,nfft,2)); |
| Line 17a: | Freq_Axis = linspace(0,fs/2,nfft/2+1); |
| Line 18a: | for band_idx = 1 : nb_bands |
| Line 19a: | lim_inf = round(freq_st(band_idx) / (fs/2) * nfft / 2) + 1; |
| Line 20a: | lim_sup = round(freq_en(band_idx) / (fs/2) * nfft / 2) + 1; |
| Line 21a: | Fbe_Trace = sum(Data_Spectrum(:,lim_inf:lim_sup).\hat{ }2,2) * 2 / nfft; |
| Line 22a: | FBE_Big_Array(frame_counter,band_idx) = Fbe_Trace; |
| Line 23a: | end |
| Line 24a: | end |

Lines 3a to 24a compute the frequency band energy for the specified frequency bands (Line:3a
and Line:4a) within the specified time frame (Line:06a). FBE_Big_Array is a two-dimensional
matrix consisting of FBE values for each frame and frequency bin number in the second
dimension. Time_vec consists of datenum values of time stamps.
4b) Root Mean Square

| | |
|---|---|
| Line 03b: | fs=1000; % Acquisition frequency |
| Line 04b: | frame_length=10; % in seconds |
| Line 05b: | frame_size = frame_length * fs; |
| Line 06b: | frame_counter = 0; |
| Line 07b: | for frame_idx = 1 : 1: floor(nb_frames_per_file) |
| Line 08b: | st_index = (frame_idx − 1)*frame_size + 1; |
| Line 09b: | end_index = st_index + frame_size − 1; |
| Line 10b: | Data = B(st_index:end_index); |
| Line 11b: | frame_counter = frame_counter + 1; |
| Line 12b: | Time_Array(frame_counter) = datenum(time_vec) + datenum([0 0 0 0 0 |
| frame_length*( | frame_idx−1)]); |
| Line 13b: | rms_data(frame_counter) = sqrt(mean(abs(Data).\hat{ }2,2)); |
| Line 14b: | end |

Lines 3b to 14b compute the root mean square within the specified time frame (Line:13b).
rms_data is a one-dimensional matrix consisting of RMS values for each frames.
4c) Envelope fit

| | |
|---|---|
| Line 03c: | [env_u env_l]=envelope(B); |

Line 03c calculates Hilbert transform of B and give upper and lower envelope.
4d) Move sum filter

| | |
|---|---|
| Line 03D: | ms=movsum(B,w); |

Line 03D calculates the moving sum filter with optimum window size w

An exemplary correlation produced according to the above algorithm is presented in FIG. 7B.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Adegboye, M., et al, “Recent Advances in Pipeline Monitoring and Oil Leakage Detection Technologies: Principles and Approaches,” Sensors 2019(19), 2548.
2. American Petroleum Institute. API RP 1175—Leak Detection Program Management,” December 2015.
3. Grattan, K. T. V., et al, “Fiber optic sensor technology: an overview,” Sensors and Actuators A: Physical, 82(1-3), 40-61.
4. Sahota, J. K. et al, “Fiber Bragg grating sensors for monitoring of physical parameters: a comprehensive review,” Opt. Eng. 59(6), 060901.
5. Korlapati, N. V. S. et al., “Review and analysis of pipeline leak detection methods,” Journal of Pipeline Science and Engineering 2(4), 100074, 2022.
6. Sharma, J., et al, “Low-Frequency Distributed Acoustic Sensing for Early Gas Detection in a Wellbore,” IEEE Sensors Journal 21(5), 6158-6169, 2021.
7. Stajanca, P., et al. “Detection of Leak-Induced Pipeline Vibrations Using Fiber-Optic Distributed Acoustic Sensing,” Sensors, 2018(18), 2841.
8. Tabjula, J., et al, “Feature Extraction Techniques for Noisy Distributed Acoustic Sensor Data Acquired in a Wellbore,” Applied Optics 62(16), 2023.
9. Gemeinhardt, H., et al, “Machine-Learning-Assisted Leak Detection Using Distributed Temperature and Acoustic Sensors,” IEEE Sensors Journal 24(2), 2024.

1. A method for detecting a leak in a component of a system for handling a fluid, the method comprising:
(a) generating a signal by sensing one or more physical parameters using one or more sensors, wherein the one or more sensors comprise optical fibers comprising fiber Bragg gratings (FBG);
(b) electronically converting the signal to data, wherein the data comprises raw FBG wavelength shift data; and
(c) performing detrending on the data to generate detrended data.

2. The method of claim 1, wherein the detrending is non-linear detrending; and wherein the parameters of the non-linear detrending are customized to a signal of interest.

3. The method of claim 1, wherein preforming detrending on the data comprises:
(a) selecting an optimum filter window size;
(b) deploying a moving average filter to generate a synthetic baseline; and
(c) subtracting the synthetic baseline from the raw FBG wavelength shift data;
wherein step (c) extracts leak-induced signatures.

4. The method of claim 1, wherein the one or more sensors comprise a first optical fiber comprising a first FBG and a second optical fiber comprising a second FBG.

5. The method of claim 4, wherein the first FBG is affected by the leak and the second FBG is not affected by the leak, and wherein the method further comprises comparing a signal from the first FBG to a signal from the second FBG.

6. The method of claim 1, further comprising performing one or more additional signal processing techniques for noise reduction.

7. The method of claim 1, wherein the fluid comprises water, crude petroleum, refined petroleum, natural gas, or any combination thereof.

8. The method of claim 1, wherein the component comprises a well, a pipeline, a storage tank, another storage structure, a transport structure, or any combination thereof.

9. The method of claim 1, wherein the component is undersea, at a land surface, or is a subsurface component on land.

10. The method of claim 1, the method further comprising quantifying the leak, wherein quantifying the leak comprises:
(a) processing the detrended data using one or more of frequency band energy (FBE), root mean square (RMS), envelope fit using Hilbert transform, and moving sum filter to generate processed data; and
(b) correlating the processed data to one or more known values for a leak rate in order to quantify the leak.

11. The method of claim 1, wherein the method is capable of detecting a leak of less than 5% of flow volume.

12. (canceled)

13. The method of claim 1, wherein the method is capable of detecting a leak rate less than 0.1 gallons per minute.

14. (canceled)

15. A system for detecting a location of a leak in a component of an apparatus for handling a fluid, the system comprising:
(a) one or more sensors comprising optical fibers, wherein the optical fibers comprise fiber Bragg gratings (FBG) for the sensing of one or more physical parameters in the component of the apparatus for handling a fluid;
(b) a detection module for receiving signal data from the one or more sensors; and
(c) a computation module for detrending the signal data according to the method of any one of claims 1-14.

16. The system of claim 15, wherein the optical fiber is an axial fiber or a helical fiber.

17. The system of claim 15, wherein the optical fiber is a single-mode optical fiber or a multi-mode optical fiber.

18. The system of claim 15, wherein the one or more sensors comprise a first optical fiber comprising a first FBG and a second optical fiber comprising a second FBG.

19. The system of claim 15, wherein the fluid comprises crude petroleum, refined petroleum, natural gas, or any combination thereof.

20. The system of claim 15, wherein the component comprises a well, a pipeline, a storage tank, another storage structure, a transport structure, or any combination thereof.

21. The system of claim 15, wherein the one or more physical parameters comprise temperature, pressure, vibration, strain, or any combination thereof.

22. The system of claim 15, wherein the signal data results from reflected wavelength from the FBG in response to physical parameter measurements.
